(19) United States
(12) Patent Application Publication
(10) Pub. No.: US 2016/0219838 A1
(43) Pub. Date: Aug. 4, 2016

(54) Pet Waste Collection Device

(71) Applicant: Kevin Flaig, Mound, MN (US)

(72) Inventor: Kevin Flaig, Mound, MN (US)

(21) Appl. No.: 15/015,833

(22) Filed: Feb. 4, 2016

Related U.S. Application Data
(60) Provisional application No. 62/111,743, filed on Feb. 4, 2015.

(51) Int. Cl. A01K 27/00; B65D 43/16; B65D 25/04

(52) U.S. Cl. CPC A01K 27/008; A01K 27/004; B65D 25/04; B65D 43/16

(57) ABSTRACT

A pet waste collection device that allows a user to store clean disposable bags and used disposable bags within a container while walking a pet. The pet waste collection device includes a container having a first compartment accessible via a first opening and a second compartment accessible via a second opening. Each opening is selectively covered via a lid. The container further includes a handle thereon for a user to hold while walking a pet. In some embodiments, the container includes a leash fastener for removably engaging a conventional pet leash. In alternate embodiments, the container includes an integrated and extendable leash that is stored in a wound configuration within the container.

### CROSS REFERENCE TO RELATED APPLICATION

This application claims the benefit of U.S. Provisional Application No. 62/111,743 filed on Feb. 4, 2015. The above identified patent application is herein incorporated by reference in its entirety to provide continuity of disclosure.

### BACKGROUND OF THE INVENTION

### Field of the Invention

The present invention relates to pet waste collection devices and pet leashes. More specifically, the present invention provides a pet waste collection device having a compartment for storing clean disposable bags and a compartment for storing used disposable bags, and that is further connectable to a leash.

It is important to clean up pet waste when taking a pet outdoors, particularly in a public place such as a public sidewalk or park. Every pet owner has a duty to clean up after his or her pet in order to maintain the cleanliness and appearance of the community. If a person fails to clean up after his or her pet, he or she may be fined by local authorities. Further, cleaning up pet waste helps to prevent the spread of germs and disease.

In order to clean up pet waste while spending time outdoors, many pet owners bring a scooping tool and one or more disposable bags when he or she walks the pet. However, carrying around a tool and disposable bags can be inconvenient and the pet owner may forget to bring such items when taking a pet for a walk. Further, once the pet waste is collected, the tool becomes unsanitary and the pet owner must carry the waste bag, which can be unpleasant. Thus, a device for allowing a user to more easily collect and store pet waste is desired.

Devices have been disclosed in the prior art that relate to pet waste collection devices. These include devices that have been patented and published in patent application publications. These devices generally relate to pet waste clean-up devices, such as U.S. Pat. No. 6,454,119, U.S. Pat. No. 7,695,034, U.S. Published Patent Application Number 2010/0237640, U.S. Published Patent Application Number 2006/0231043, and U.S. Pat. No. 8,347,825.

The devices in the prior art have several known drawbacks. Such devices provide containers for collecting pet waste that further provide means for securement to a pet leash. However, these devices fail to provide means for separately storing both clean and used disposable bags, requiring the user to hold the clean bags, the used bags, or both. Thus, a device that can be secured to a leash and that provides storage for clean and used bags is desired.

In light of the devices disclosed in the prior art, it is submitted that the present invention substantially diverges in design elements from the prior art and consequently it is clear that there is a need in the art for an improvement to existing pet waste collection devices. In this regard the instant invention substantially fulfills these needs.

### SUMMARY OF THE INVENTION

In view of the foregoing disadvantages inherent in the known types of pet waste collection devices now present in the prior art, the present invention provides a new pet waste collection device wherein the same can be utilized for providing convenience for the user when cleaning-up pet waste while walking a pet.

A pet waste collection device for use in allowing a pet owner to more easily clean up pet waste while walking a pet. The pet waste collection device comprises a container having an open first end and an open second end. The open first end provides access to a first compartment, and the open second end provides access to a second compartment. The first end includes a lid pivotally secured thereon, wherein the lid includes an opening thereon through which disposable bags can be removed from the interior of the first compartment. The second end includes a lid pivotally affixed thereto. The container further includes a handle thereon for a user to hold. The device is further removably securable with a conventional leash or includes an integrated, extendable leash, depending upon the embodiment.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the pet waste collection device.

FIG. 2 shows a cross sectional view of the container of the pet waste collection device.

FIG. 3 shows a perspective view of an alternate embodiment of the pet waste collection device.

FIG. 4 shows a side cross sectional view of an alternate embodiment of the pet waste collection device.

### DETAILED DESCRIPTION OF THE INVENTION

Reference is made herein to the attached drawings. Like reference numerals are used throughout the drawings to depict like or similar elements of the pet waste collection device. For the purposes of presenting a brief and clear description of the present invention, the preferred embodiment will be discussed as used for cleaning-up pet waste while walking a pet. The figures are intended for representative purposes only and should not be considered to be limiting in any respect.

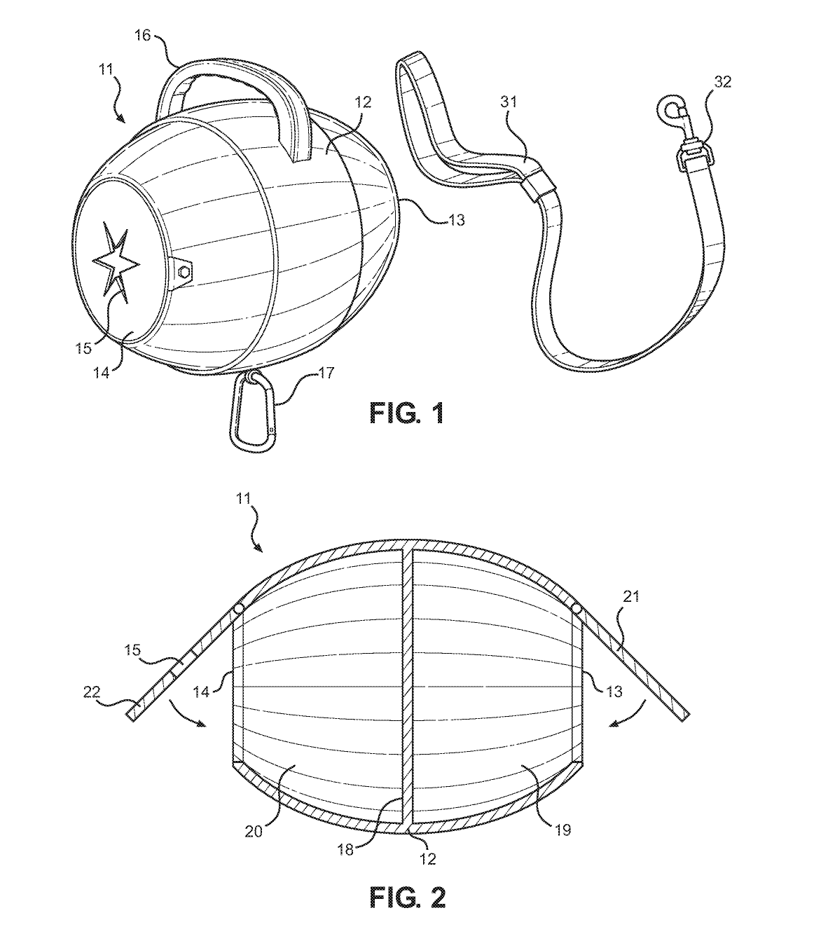

Referring now to FIGS. 1 and 2, there is shown a perspective view of the pet waste collection device and a cross sectional view of the container of the pet waste collection device, respectively. The pet waste collection device 11 comprises a container 12 having a first end 13 and a second end 14. In the illustrated embodiment, the container 12 comprises a barrel-shaped configuration. However, in alternate embodiments, the container 12 may have other shapes, such as a cylindrical configuration, among others. The container 12 is substantially hollow and includes a first compartment 19 and a second compartment 20 separated via a dividing wall 18.

A handle 16 extends from the exterior of the container 12, wherein the handle 16 is adapted to be held in a hand of the user. The handle 16 is shown as having a rounded or C-shaped configuration, however, in alternate embodiments, other types of handles 16 may be provided. Further, the handle 16 is positioned laterally on the container 12 so as to extend along a portion of the perimeter thereof. In some embodiments, the handle 16 includes padding thereon or ridges for allowing the user to more easily and more comfortably grasp the handle 16.

In the illustrated embodiment, a leash fastener 17 extends from the exterior of the container 12. The leash fastener 17 is preferably located on the opposing side of the container 12 as the handle 16. The leash fastener 17 is shown as a carabiner, however, alternate types of locking fasteners, such as any of various clips and clasps may be used. The leash fastener 17 is adapted to removably engage with a conventional pet leash 31. In operation, an end of the pet leash 31 is formed into a loop and secured to the container 12 via the leash fastener 17 thereon. The free end of the leash 31 includes a collar fastener 32 thereon for securement to the collar of a pet.

The container 12 comprises an open first end 13 and an open second end 14. The open first end 13 provides access to a first compartment 19 in which used disposable bags filled with pet waste can be positioned for storage. The open first end 13 further includes a first lid 21 pivotally affixed thereto via a hinge, wherein the first lid 21 seals the open first end 13. In alternate embodiments, the first lid 21 is completely removable from the open first end 13 and is secured thereon via press fit or threaded engagement. The first lid 21 prevents odors from escaping the first compartment 19 and also helps to prevent the filled bags from escaping the container 12 if the container 12 is tilted or dropped.

The open second end 14 provides access to a second compartment 20. The second compartment 20 is adapted to store one or more clean or new disposable bags, such as disposable plastic waste bags. The bags are preferably stored in a roll configuration. A second lid 22 covers the open second end 14 so as to enclose the bags therein. The second lid 22 preferably comprises an opening 15 thereon through which the bags can be removed from the second compartment 20. In this way, the bags can be retrieved in a sequential manner by threading the bags through the opening 15. This also eliminates the need for the user to open the second lid 22 to access the bags.

The interior of the container 12 comprises a dividing wall 18 that separates the first compartment 19 from the second compartment 20. Preferably, the dividing wall 18 extends across the interior volume of the container 12 and fully separates the first and second compartments 19, 20. The dividing wall 18 is substantially perpendicular to the longitudinal axis of the container 12, wherein the longitudinal axis extends from the first end 13 to the second end of the container 14. The dividing wall 18 further prevents the used bags from contaminating the clean bags.

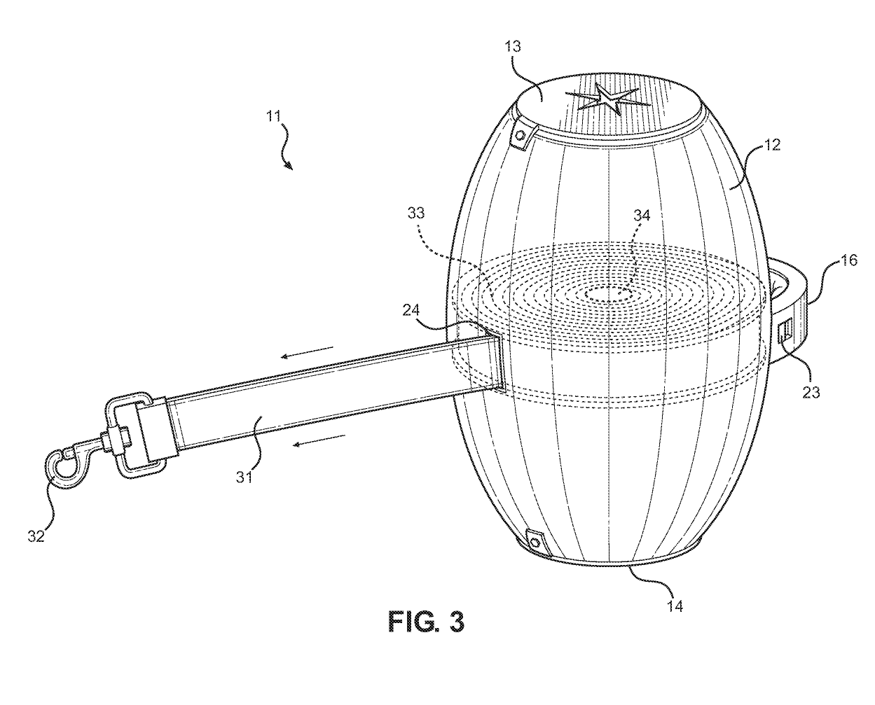

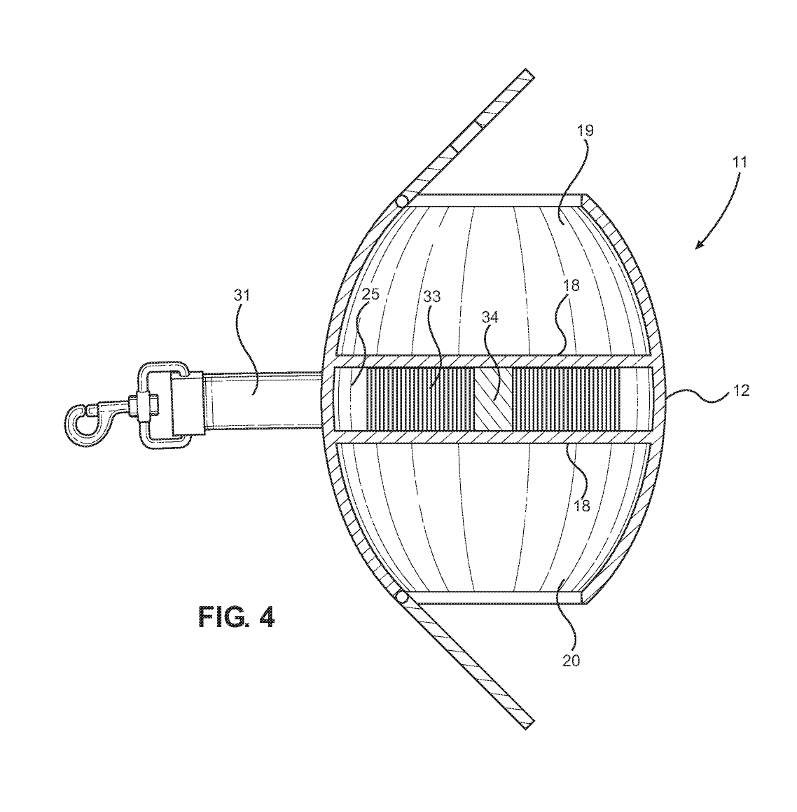

Referring now to FIGS. 3 and 4, there is shown a perspective view of an alternate embodiment of the pet waste collection device and a side cross sectional view of the pet waste collection device, respectively. In an alternate embodiments, the pet waste collection device 11 comprises a container 12 having a retractable leash 31 integrated therein. The leash 31 is wound on a spool 34 within the container 12. A first end of the leash having a collar fastener 32 thereon extends through a slot 24 on the container 12 so that the collar fastener 32 is on the exterior of the container 12. The collar fastener 32 is sized so as to be unable to pass through the slot 24. This prevents the leash 31 from being fully retracted into the container 12. The user can then pull on the free end of the leash 31 in order to withdraw an additional length of leash 31 from the interior of the container 12. Alternatively, the user can retract the leash into the container 12 so as to wind the leash on the spool 34 within the interior of the container 12.

A control 23 is disposed on the handle 16 and is operably connected to a retraction mechanism that allows the leash to extend or retract onto the spool 34. The spool 34 preferably serves as the retraction mechanism, and the spool may be spring-biased so as to wind the leash onto the spool 34. Thus, the user can operate the control 23 to extend the leash 31 to a desired length and can then release the control 23 to lock the leash 31 at that length. It is not desired to limit the specific type of retraction mechanism utilized, and any retraction mechanism known in the art that allows the leash to be extended and retracted can be used consistently with the disclosure of the present invention.

The container 12 includes an open first end and an open second end, wherein each end is pivotally covered by a lid. The open first end provides access to a first compartment 19 and the open second end provides access to a second compartment 20. A wound portion 33 of the leash 31 is stored on a spool 34 located in a central compartment 25 that is separated from the first compartment 19 and second compartment 20 via a pair of dividing walls 18. In this way, the leash 31 is not accessible via the first or second compartment.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pet waste collection device, comprising:
a container having an open first end and an open second end;
a first compartment accessible via the open first end;
a second compartment accessible via the open second end;
a first lid selectively covering the open first end;
a second lid selectively covering the open second end;
a leash fastener disposed on the container and adapted to be removably secured to a leash.

2) The pet waste collection device of claim 1, wherein the container comprises a barrel shape.

3) The pet waste collection device of claim 1, wherein the first compartment is separated from the second compartment via a dividing wall disposed within the container.

4) The pet waste collection device of claim 1, wherein the leash fastener comprises a carabiner.

5) The pet waste collection device of claim 1, wherein the second lid comprises an opening thereon through which a disposable bag stored within the second compartment can be threaded for removal from the second compartment.

6) The pet waste collection device of claim 1, wherein the first lid is pivotally affixed to the first end of the container.

7) A pet waste collection device, comprising:
a container having an open first end and an open second end;
a first compartment accessible via the open first end;
a second compartment accessible via the open second end;
a first lid selectively covering the open first end;
a second lid selectively covering the open second end;
a leash stored in a wound configuration within the container, wherein a free end of the leash extends outward from the container via a slot thereon such that the leash is extendable from the container.

8) The pet waste collection device of claim 7, further comprising a retraction mechanism adapted to allow the leash to be extended or retracted from the container.

9) The pet waste collection device of claim 7, further comprising a control adapted to allow the leash to be selectively extended and retracted from the container.

10) The pet waste collection device of claim 7, wherein the leash is stored within a central compartment within the container.
